(19) United States
(12) Patent Application Publication
(10) Pub. No.: US 2023/0177875 A1
(43) Pub. Date: Jun. 8, 2023

(54) SYSTEM AND METHOD FOR CONTROLLING VIEWING OF MULTIMEDIA BASED ON BEHAVIOURAL ASPECTS OF A USER

(71) Applicant: RAVINDRA KUMAR TARIGOPPULA, HYDERABAD (IN)

(72) Inventor: RAVINDRA KUMAR TARIGOPPULA, HYDERABAD (IN)

(21) Appl. No.: 17/997,371

(22) PCT Filed: Jun. 17, 2020
(86) PCT No.: PCT/IB2020/055629

§ 371 Date: Oct. 28, 2022

(30) Foreign Application Priority Data
May 5, 2020 (IN) 202041019122

(51) Int. Cl. G06V 40/16; G06V 20/52

(52) U.S. Cl. CPC G06V 40/171; G06V 20/52; G06V 40/176

(57) ABSTRACT

A system for controlling viewing of multimedia is provided. The system includes an image capturing module captures images or videos of a user while viewing the multimedia. A mouth gesture identification module extracts facial features from the images captured of the user; identifies mouth gestures of the user based on the facial features extracted. A training module analyses the mouth gestures identified to determine parameters; builds a personalised support model for the user based on the parameters determined. A prediction module receives real-time images captured, wherein the real-time images are captured while viewing the multimedia; extract real-time facial features from the real-time images captured; identifies real-time mouth gestures of the user based on the real-time facial features extracted; analyze the real-time mouth gestures identified to determine real-time parameters; compare the real-time parameters determined with the personalized support model built for the user, and control outputs based on compared data.

This International Application claims priority from a complete patent application filed in India having Patent Application No. 202041019122, filed on May 05, 2020 and titled “SYSTEM AND METHOD FOR CONTROLLING VIEWING OF MULTIMEDIA BASED ON BEHAVIOURAL ASPECTS OF A USER”.

### FIELD OF THE INVENTION

Embodiments of the present disclosure relate to controlling interactive systems, and more particularly to, a system and a method for controlling viewing of multimedia.

### BACKGROUND

Over the years, the use of electronic mobile devices, such as including, but not limited to, a smartphone, a laptop, a television, and a tablet, has exponentially increased. Today, on the electronic device, an individual is enabled to including, but not limited to, play games, and watch videos.

As electronic devices have become an integrated part of an individual's day-to-day life, it has become a norm to use the electronic devices throughout the day while doing daily chores. For example, an individual may be an elderly person who might be watching a movie while consuming food. Often, we get subsumed in the movie that we forget to chew or may laugh at a scene from a movie and may end up choking due to food getting stuck while consuming. The elderly person may end up choking and may need to alert a nearby individual to help the elderly person overcome the choking caused by food while consuming. However, the current systems available do not monitor the consumption of food which may lead to fatal mishaps. Such choking is the cause of tens of thousands of deaths worldwide every year with the elderly. Choking while consuming food is the 4th leading cause of unintentional injury death. Thousands of deaths among people aged ≥65 were attributed to choking of food.

Another example is to consider a child who is shown a video of a cartoon to help the child consume food. Almost all kids born in the last decade watch a video while eating. However, the child may get so engrossed in watching the video, that the child may forget to chew or swallow and soon the child may refuse to eat altogether. Currently, the existing systems do not monitor the chewing patterns of a child and help the child eat the food, thereby resulting in less consumption of food in a greater amount of time, compared to eating without watching videos

According to the American Academy of Pediatrics (AAP), one child dies every five days from choking on food, making it the leading cause of death in children ages 14 and under. Currently, there is no system that monitors if the child is choking and alert the people responsible for the safety of the child.

Therefore, there exists a need for an improved system that can overcome the aforementioned issues.

### BRIEF DESCRIPTION

In accordance with one embodiment of the disclosure, a system for controlling viewing of multimedia is provided. The system includes an image capturing module operable by the one or more processors, wherein the image capturing module is configured to capture multiple images or videos of a face of a user while viewing the multimedia. The system also includes a mouth gesture identification module operable by the one or more processors, wherein the mouth gesture identification is configured to extract multiple facial features from the multiple images or videos captured of the face of the user using an extracting technique, and identify mouth gestures of the user based on the multiple facial features extracted using a processing technique. The system also includes a training module operable by the one or more processors, wherein the training module is configured to analyse the mouth gestures identified of the user to determine one or more parameters of the user using a pattern analysis technique and build a personalised support model for the user based on the one or more parameters determined of the user. The system also includes a prediction module operable by the one or more processors, wherein the prediction module is configured to receive a multiple real-time images captured from the image capturing module, wherein the multiple real-time images of the user is captured while viewing the multimedia; extract multiple real-time facial features from the multiple real-time images captured of the face of the user using the extracting technique via the processing module; identify real-time mouth gestures of the user based on the multiple real-time facial features extracted using the processing technique via the processing module; analyse the real-time mouth gestures identified of the user to determine one or more real-time parameters of the user using the pattern analysis technique; compare the one or more parameters determined with the personalised support model built for the user; and control one or more outputs based on comparison of the one or more parameters determined with the personalised support model built for the user.

In accordance with another embodiment of the disclosure, a method for controlling viewing of multimedia is provided. The method includes capturing, by an image capturing module, a plurality of images of a face of a user while viewing the multimedia; extracting, by a mouth gesture identification module, a plurality of facial features from the plurality of images captured of the face of the user using an extracting technique; identifying, by the mouth gesture identification module, mouth gestures of the user based on the plurality of facial features extracted using a processing technique; analysing, by a training module, the mouth gestures identified of the user to determine one or more parameters of the user using a pattern analyses technique; building, by the training module, a personalised support model for the user based on the one or more parameters determined; receiving, by a prediction module, a plurality of real-time images captured from the image capturing module, wherein the plurality of real-time images of the user is captured while viewing the multimedia; extracting, by the prediction module, a plurality of real-time facial features from the plurality of real-time images captured of the face of the user using the extracting technique via the processing module; identifying, by the prediction module, real-time mouth gestures of the user based on the plurality of real-time facial features extracted using the processing technique via the processing module; analysing, by the prediction module, the real-time mouth gestures identified of the user to determine one or more real-time parameters of the user using the pattern analysis technique; comparing, by the prediction module, the one or more parameters determined with the personalised support model built for the user; and controlling, by the prediction module, one or more outputs based on comparison of the one or more parameters determined with the personalised support model built for the user.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 illustrates a block diagram of a system for controlling viewing of multimedia in accordance with an embodiment of the present disclosure;

FIG. 2 illustrates a block diagram of an exemplary embodiment of FIG. 1 in accordance with an embodiment of the present disclosure;

FIG. 3 illustrates a block diagram representation of a processing subsystem located on a local or a remote server in accordance with an embodiment of the present disclosure; and

FIG. 4 illustrates a flow chart representing steps involved in a method for FIG. 1 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

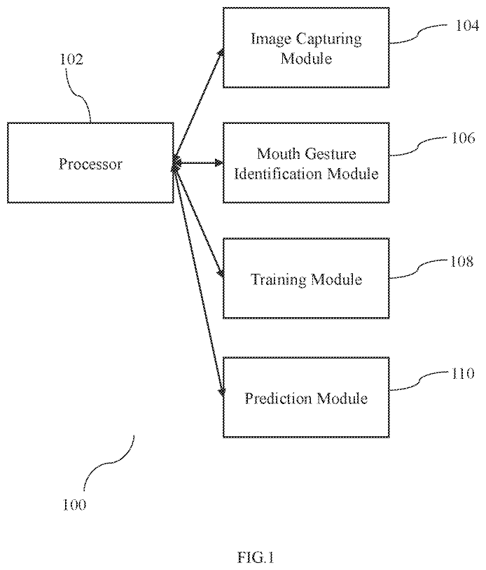

FIG. 1 illustrates a block diagram of a system (100) for controlling viewing of multimedia in accordance with an embodiment of the present disclosure. The system (100) includes one or more processors (102) that operate an image capturing module (104), a mouth gesture identification module (106), a training module (108) and a prediction module (110). In one embodiment, the system (100) may be embedded in a computing device such as including, but not limited to, a smartphone, a laptop, a tablet, a CCTV camera, companion robots or the like. In another embodiment, an independent computing device extended with the camera. The image capturing module (104) captures multiple images or videos of a face of a user, wherein the user is facing the image capturing module while watching multimedia. In one embodiment, the user is including, but not limited to, an individual ranging from a child to an elderly person. In one embodiment, the image capturing module (104) represents a front-facing camera. In one embodiment, the multimedia includes, but not limited to, videos, slideshows, movies, and series. The multiple images or videos captured are sent to the mouth gesture identification module (106), wherein the mouth gesture identification module (106) extracts multiple facial features from the multiple images or videos captured of the face of the user using an extracting technique. In one embodiment, the extracting technique may include adaptive deep metric learning technique for facial expression recognition In one embodiment, the multiple facial features are including, but not limited to, size of the face, the shape of the face, a plurality of components related to the face of the user such as including, but not limited to, size of the head of the user, and prominent features of the face of the user. Once the multiple facial features are extracted, the mouth gesture identification module (106) identifies the mouth gestures of the user based on the multiple facial features extracted using a processing technique. In one embodiment, the mouth gesture identification module (106) also determines a count of chewing movement based on the mouth gestures identified of the user and detects a state of choking while chewing or swallowing or a combination thereof, based on the mouth gestures identified of the user. In one embodiment, the processing technique may include adaptive deep metric learning technique for facial expression recognition. The mouth gestures identified of the user are sent to the training module (108), wherein the training module (108) analyses the mouth gestures identified of the user to determine one or more parameters of the user using a pattern analysis technique. In one embodiment, the one or more parameters are chewing, not chewing, swallowing and not swallowing. Upon determining the one or more parameters of the user, the training module (108) builds a personalised support model for the user based on the mouth gestures analysed. In one embodiment, the personalized support model includes, but not limited to, the amount of time the user takes to chew the food completely, the number of times the food is chewed before being swallowed, the time gap between swallowing one bite of food to eating the next. In one embodiment, the personalized support model built is stored in a database hosted in a server.

The image capturing module (104) captures multiple real-time images of the face of the user while the user is watching multimedia on the computing device. The multiple real-time images captured are sent to the prediction module (110). The prediction module (110) extracts multiple real-time facial features of the user from the multiple real-time images captured using the extracting technique via the mouth gesture identification module (106). The prediction module (110) then identifies real-time mouth gestures of the user based on the multiple real-time facial features extracted using the processing technique via the mouth gesture identification module (106). Upon identifying the real-time mouth gestures of the user, the prediction module (110) analyses the real-time mouth gestures of the user to determine one or more real-time parameters of the user using the pattern analysis technique. The prediction module (110) then compares the one or more parameters determined with the personalised support model build for the user. Based on the comparison, the prediction module (110) controls one or more outputs. In one embodiment, the one or more outputs are including, but not limited to, pausing the multimedia being viewed by the user, recommend or, train the user unconsciously to link chewing with playing video, and not-chewing with not-playing video the help user to swallow food and resume the multimedia paused for viewing of the user.

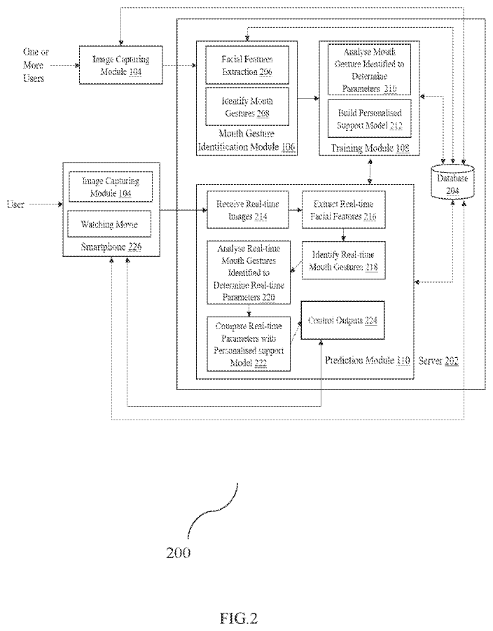

FIG. 2 illustrates a block diagram of an exemplary embodiment (200) of FIG. 1 in accordance with an embodiment of the present disclosure. One or more users are viewing multimedia facing a smartphone (226). For example, there are 2 users, i.e., a first user—an elderly person and a second user—a child, viewing a movie. The image capturing module (104), i.e., the front-facing camera, captures multiple images or videos of both the users individually. In one embodiment, the multiple images or videos captured are stored in a database (204) hosted in one of a local server or a remote server (202). The multiple images or videos captured are sent to the mouth gesture identification module (106) to extract multiple facial features (206) of each of the 2 users from the multiple images or videos captured of the two users using an extracting technique. The database and the application processing server can be on device, on-premises or remote, and the connection can be wired or wireless medium such as Wi-Fi, Bluetooth, NFC, radio signals, IR or the like.

In one embodiment, the multiple facial features extracted (206) of each of the 2 users are stored in the database (204). In one embodiment, the multiple facial features include, but not limited to, size of the face, the shape of the face, a plurality of components related to the face of each of the 2 users such as including, but not limited to, size of the head of each of the 2 users, and prominent features of the face of each of the 2 users. The mouth gesture identification module (106) then identifies mouth gestures (208) of each of the two users based on the multiple facial features extracted (206) using a processing technique. In one embodiment, the mouth gestures identified (208) of each of the 2 users are stored in the database (204). The mouth gestures identified (208) of each of the 2 users are sent to the training module (108). The training module (108) analyses the mouth gestures identified of each of the 2 users to determine one or more parameters (210) of each of the 2 users using a pattern analysis technique, and then the training module (108) builds a personalised support model (212) for each of the 2 users based on the one or more parameters determined (210) of each of the 2 users respectively. In one embodiment, the personalised support model built (212) for each of the 2 users are stored in the database (204).

Once the training is completed, for example, one of the 2 users is watching a movie facing the smartphone (226) screen, wherein the image capturing module (104), i.e., the front-facing camera, captures multiple real-time images of the face of the user. The multiple real-time images captured (214) of the face of the user are sent to the prediction module (110). The prediction module (110) extracts multiple real-time facial features (216) from the multiple real-time images captured using an extracting technique via the mouth gesture identification module (106). Based on the multiple real-time facial features extracted (216), the user is identified as the second user-the child. The prediction module (110) then identifies real-time mouth gestures (218) of the user based on the multiple real-time facial features extracted (216) of the second user. Based on the real-time mouth gestures identified (218) of the user, the prediction module (110) determines the one or more real-time parameters (220), i.e., if the child is chewing, swallowing, or has stopped chewing. For example, the one or more real-time parameters determined (220) are not chewing and swallowing. The one or more parameters determined (220) are then compared with the personalized support model built (222) for the child. For example, the personalized support model built for the child (212) includes that the child, regularly, chews food within 15 seconds and then swallows and then takes another bite of food, thereby continuing the process until the food is completed. Based on the comparison, the one or more real-time parameters determined (220) of the child is that the child was chewing for 5 seconds, stopped chewing and not swallowed. Since the child has stopped chewing and not swallowing the food as well, the prediction module (110) will pause the movie (224) being watched by the child and prompts a notification on the screen for the child to continue eating to un-pause (224) the video. In such embodiment, the pause the movie (224) being watched by the child may be achieved with or without receiving the notification. Once the child starts to eat again, the prediction module (110) un-pauses (224) the movie, wherein the prediction module (110) detects if the child has started to eat is determined by the multiple real-time images captured, and analyzed the real-time mouth gestures of the child based on the multiple real-time images captured of the child and compared with the personalized support model built for the child.

Similarly, an elderly person is recognised by the prediction module (110) and the prediction module identifies the mouth gestures of the elderly person and determine the one or more parameters, i.e., the prediction module (110) determines that the elderly person is not swallowing and not chewing. The prediction module (110) compares the one or more parameters determined with the personalised support model built for the elderly person. Upon comparison, the prediction module (110) determines that the elderly person is choking and alerts the people around the elderly person to help overcome the choking.

In one exemplary embodiment, the system may generate a notification for the user to help overcome the choking even when the user is not viewing the multimedia.

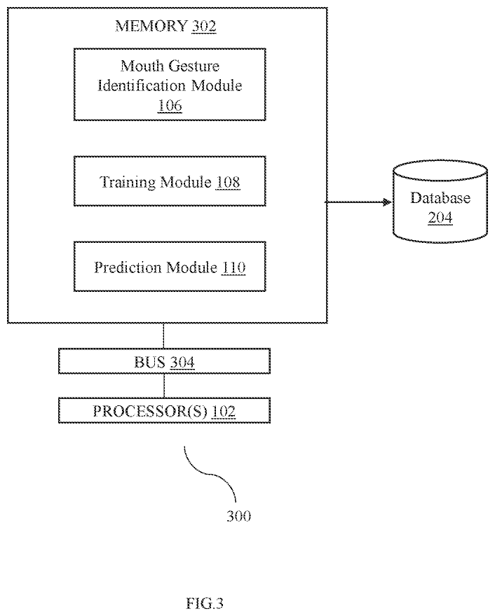

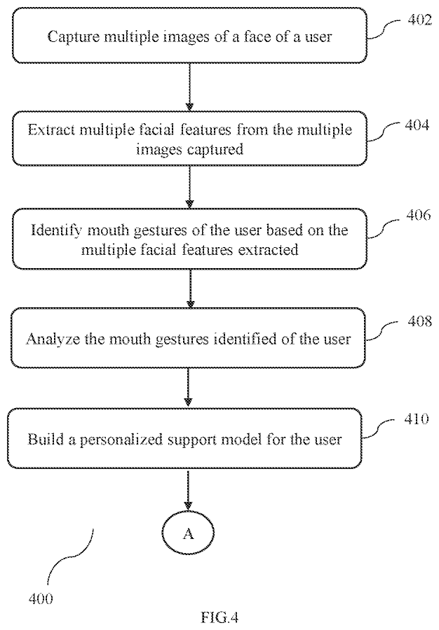

FIG. 3 illustrates a block diagram representation of a processing subsystem (300) located on a local or a remote server in accordance with an embodiment of the present disclosure. The system includes the processor(s) (306), bus (304) and memory (302) coupled to the processor(s) (102) via the bus (304), and the database (202). The processor(s) (102), as used herein, means any type of computational circuit, such as but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof. The bus as used herein is a communication system that transfers data between components inside a computer, or between computers.

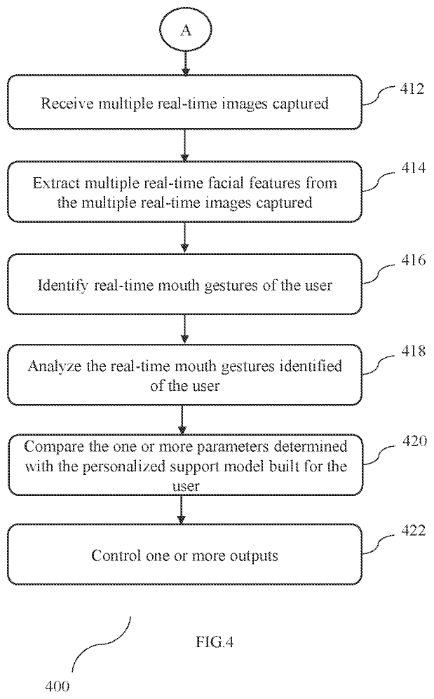

The memory (302) includes a plurality of modules stored in the form of an executable program that instructs the processor to perform the method steps illustrated in FIG. 4. The memory (302) has the following modules: the mouth gesture identification module (106), the training module (108), and the prediction module (110). Computer memory elements may include any suitable memory device for storing data and executable programs, such as read-only memory, random access memory, erasable programmable read-only memory, electrically erasable programmable read-only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. The executable program stored on any of the above-mentioned storage media may be executable by the processor(s) (102).

The mouth gesture identification module (106) is configured to extract a plurality of facial features from the plurality of images captured of the face of the user using an extracting technique, and identify mouth gestures of the user based on the plurality of facial features extracted using a processing technique. The training module (108) is configured to analyse the mouth gestures identified of the user to determine one or more parameters of the user using a pattern analysis technique and build a personalised support model for the user based on the one or more parameters determined of the user. The prediction module (110) is configured to receive a plurality of real-time images captured from the image capturing device, wherein the plurality of real-time images of the user is captured while viewing the multimedia; extract a plurality of real-time facial features from the plurality of real-time images captured of the face of the user using the extracting technique via the mouth gesture identification module (106); identify real-time mouth gestures of the user based on the plurality of real-time facial features extracted using the processing technique via the mouth gesture identification module (106); analyse the real-time mouth gestures identified of the user to determine one or more real-time parameters of the user using the pattern analysis technique; compare the one or more parameters determined with the personalised support model built for the user; and control one or more outputs based on comparison of the one or more parameters determined with the personalised support model built for the user.

FIG. 4 illustrates a flow chart representing steps involved in a method (400) thereof of FIG. 1 in accordance with an embodiment of the present disclosure. The method (400) includes capturing multiple images or videos of a face of a user, in step 402. The method (400) includes capturing, by an image capturing module, the multiple images or videos of the face of the user while viewing the multimedia. The image capturing module captures multiple images or videos of a face of a user, wherein the user is facing the image capturing module while watching multimedia. In one embodiment, the image capturing module represents a front-facing camera. In one embodiment, the multimedia includes, but not limited to, videos, slideshows, movies, and series. The method (400) includes extracting multiple facial features from the multiple images or videos captured, in step 404. The method (400) includes extracting, by a mouth gesture identification module, the multiple facial features from the multiple images or videos captured of the face of the user using an extracting technique. In one embodiment, the multiple facial features are including, but not limited to, size of the face, the shape of the face, a plurality of components related to the face of the user such as including, but not limited to, size of the head of the user, neck region, that provides secondary confirmation for swallowing, and prominent features of the face of the user. The method (400) includes identifying mouth gestures of the user based on the multiple facial features extracted, in step 406. The method (400) includes identifying, by the mouth gesture identification module, the mouth gestures of the user based on the plurality of facial features extracted using a processing technique. In one embodiment, the mouth gesture identification module also determines a count of chewing movement based on the mouth gestures identified of the user and detects a state of choking while chewing or swallowing or a combination thereof, based on the mouth gestures identified of the user. The method (400) includes analysing the mouth gestures identified of the user, in step 408. The method (400) includes analysing, by a training module, the mouth gestures identified of the user to determine one or more parameters of the user using a pattern analysis technique. In one embodiment, the one or more parameters are chewing, not chewing, swallowing and not swallowing. The method (400) includes building a personalized support model for the user, in step 410. The method (400) includes building, by the training module, the personalised support model for the user based on the one or more parameters determined. In one embodiment, the personalized support model includes, but not limited to, the amount of time the user takes to chew the food completely, the number of times the food is chewed before being swallowed, the time gap between swallowing one bite of food to eating the next.

The method (400) includes receiving multiple real-time images captured, in step 412. The method (400) includes receiving, by a prediction module, the multiple real-time images captured from the image capturing module, wherein the multiple real-time images of the user are captured while viewing the multimedia. The method (400) includes extracting multiple real-time facial features from the multiple real-time images captured, in step 414. The method (400) includes extracting, by the prediction module, the multiple real-time facial features from the multiple real-time images captured of the face of the user using the extracting technique via the mouth gesture identification module. The method (400) includes identifying real-time mouth gestures of the user, in step 416. The method (400) includes identifying, by the prediction module, the real-time mouth gestures of the user based on the multiple real-time facial features extracted using the processing technique via the mouth gesture identification module. The method (400) includes analysing the real-time mouth gestures identified of the user, in step 418. The method (400) includes analysing, by the prediction module, the real-time mouth gestures identified of the user to determine one or more real-time parameters of the user using the pattern analysis technique. The method (400) includes comparing the one or more parameters determined with the personalised support model built for the user, in step 420. The method (400) includes comparing, by the prediction module, the one or more parameters determined with the personalised support model built for the user. The method (400) includes controlling one or more outputs, in step 422. The method (400) includes controlling, by the prediction module, the one or more outputs based on a comparison of the one or more parameters determined with the personalised support model built for the user. In one embodiment, the one or more outputs are including, but not limited to, pausing the multimedia being viewed by the user, recommend the user to swallow food and resume the multimedia paused for viewing of the user.

The system and method for controlling viewing of multimedia, as disclosed herein, provides various advantages, including but not limited to, monitors if the user is chewing and swallowing food on time while viewing multimedia, prompts the user to continue eating by pausing the multimedia being viewed by the user, recognizes if the user choking while consuming food. Further, the system is enabled to collaborate with any streaming services, inbuilt multimedia viewing services.

While specific language has been used to describe the disclosure, any limitations arising on account of the same are not intended. As would be apparent to a person skilled in the art, various working modifications may be made to the method in order to implement the inventive concept as taught herein. The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

I/We claim:

1. A system (100) for controlling viewing of multimedia, comprising:
one or more processors (102);
an image capturing module (104) operable by the one or more processors (102), wherein the image capturing module (104) is configured to capture a plurality of images or videos of a face of a user while viewing the multimedia;
a mouth gesture identification module (106) operable by the one or more processors (102), wherein the mouth gesture identification module (106) is configured to:
extract a plurality of facial features from the plurality of images or videos captured of the face of the user using an extracting technique; and
identify mouth gestures of the user based on the plurality of facial features extracted using a processing technique;
a training module (108) operable by the one or more processors (102), wherein the training module (108) is configured to:
analyze the mouth gestures identified of the user to determine one or more parameters of the user using a pattern analysis technique; and
build a personalised support model for the user based on the one or more parameters determined of the user; and
a prediction module (110) operable by the one or more processors (102), wherein the prediction module (110) is configured to:
receive a plurality of real-time images or videos captured from the image capturing module, wherein the plurality of real-time images or videos of the user is captured while viewing the multimedia;
extract a plurality of real-time facial features from the plurality of real-time images or videos captured of the face of the user using the extracting technique via the mouth gesture identification module (106);
identify real-time mouth gestures of the user based on the plurality of real-time facial features extracted using the processing technique via the mouth gesture identification module (106);
analyze the real-time mouth gestures identified of the user to determine one or more real-time parameters of the user using the pattern analysis technique;
compare the one or more parameters determined with the personalized support model built for the user; and
control one or more outputs based on a comparison of the one or more parameters determined with the personalised support model built for the user.

2. The system (100) as claimed in claim 1, wherein the computing device comprises a smartphone, a laptop, a tablet, a television (TV), a standalone camera, and a companion robot

3. The system (100) as claimed in claim 1, wherein the user comprises one of a child, an adolescent, an adult, an elder person.

4. The system (100) as claimed in claim 1, wherein the plurality of facial features comprising a size of the face, a shape of the face, a plurality of components related to the face of the user and a neck region.

5. The system (100) as claimed in claim 1, wherein the one or more parameters comprises chewing, not chewing, swallowing, and not swallowing.

6. The system (100) as claimed in claim 1, wherein the mouth gesture identification module (106) is configured to:
determine a count of chewing movement based on the mouth gestures identified of the user; and
detect a state of choking while chewing or swallowing or a combination thereof, based on the mouth gestures identified of the user.

7. The system (100) as claimed in claim 1, wherein the one or more outputs comprises pausing the multimedia being viewed by the user, recommend the user to swallow food, and resume the multimedia paused for viewing of the user.

8. A method (400) for controlling viewing of multimedia, comprising:
capturing (402), by an image capturing module, a plurality of images or videos of a face of a user while viewing the multimedia;
extracting (404), by a mouth gesture identification module, a plurality of facial features from the plurality of images or videos captured of the face of the user using an extracting technique;
identifying (406), by the mouth gesture identification module, mouth gestures of the user based on the plurality of facial features extracted using a processing technique;
analysing (408), by a training module, the mouth gestures identified of the user to determine one or more parameters of the user using a pattern analysis technique;
building (410), by the training module, a personalised support model for the user based on the one or more parameters determined;
receiving (412), by a prediction module, a plurality of real-time images or videos captured from the image capturing module, wherein the plurality of real-time images or videos of the user is captured while viewing the multimedia;
extracting (414), by the prediction module, a plurality of real-time facial features from the plurality of real-time images or videos captured of the face of the user using the extracting technique via the mouth gesture identification module;
identifying (416), by the prediction module, real-time mouth gestures of the user based on the plurality of real-time facial features extracted using the processing technique via the mouth gesture identification module;
analyzing (418), by the prediction module, the real-time mouth gestures identified of the user to determine one or more real-time parameters of the user using the pattern analysis technique;
comparing (420), by the prediction module, the one or more parameters determined with the personalised support model built for the user; and
controlling (422), by the prediction module, one or more outputs based on a comparison of the one or more parameters determined with the personalised support model built for the user.

9. The method (400) as claimed in claim 8, wherein controlling the one or more outputs comprises pausing the multimedia being viewed by the user, recommending the user to swallow food, and resuming the multimedia paused for viewing of the user.

10. The method (400) as claimed in claim 8, comprising:
determining, by the mouth gesture identification module, count of chewing movement based on the mouth gestures identified of the user; and
detecting, by the mouth gesture identification module, a state of choking while chewing or swallowing or a combination thereof, based on the mouth gestures identified of the user.
